(19) United States
(12) Patent Application Publication
(10) Pub. No.: US 2010/0115255 A1
(43) Pub. Date: May 6, 2010

(54) System and Method of Dynamically Building a Behavior Model on a Hardware System

(76) Inventors: Jim Vito, Missoula, MT (US); Patrick Brown, Commerce City, CO (US)

Correspondence Address: JEAN KYLE, P. O. BOX 2274, HAMILTON, MT, 59840-4274, US

(21) Appl. No.: 12/611,437

(22) Filed: Nov. 3, 2009

Related U.S. Application Data
(60) Provisional application No. 61/110,840, filed on Nov. 3, 2008.

(51) Int. Cl. G06F 15/177

(52) U.S. Cl. 713/1

(57) ABSTRACT

A control system is dynamically built directly on a target hardware system. A host application on a host computer provides an interface to download configuration building blocks for the control system directly onto the target hardware. The host application is used to define building block type and connectivity. Microprocessor execution control of the system as well as block priority can likewise by defined by the host application.

### CROSS-REFERENCE TO RELATED APPLICATIONS

This application claims the benefits of U.S. Provisional Application No. 61/110,840 filed Nov. 3, 2008, the disclosure of which is hereby incorporated by reference in its entirety including all figures, tables and drawings.

### STATEMENT REGARDING FEDERALLY SPONSORED RESEARCH OR DEVELOPMENT

Not Applicable

### REFERENCE TO SEQUENCE LISTING, A TABLE, OR COMPUTER PROGRAM LISTING COMPACT DISC APPENDIX

Not Applicable

### FIELD OF THE INVENTION

The present invention relates to building a behavior model for an electronic hardware control system—in particular to the dynamic building of the behavior model directly on the production hardware platform.

### BACKGROUND OF THE INVENTION

This application relates to the design of an electronic control system. Various types of systems utilize a processor to control the system. An example of a system is an automotive controller that manages the operation of the automobile. Another example system is a heating and ventilation controller that manages the operation of the climate control in a building. The processor contains a circuit board with software or firmware that includes program instructions relevant to the operation of the system. Presently, it is difficult and time consuming to develop and update the behavior of the control system. Thus, there is a need in the art for a system and method of dynamically updating the behavior of a control system more efficiently.

Electronic control system development has always been a difficult task. It requires a broad scope of expertise including control system engineering, electrical engineering, system (firmware) engineering, and high-level software engineering. As control system hardware continues to advance at a pace governed by Moore's Law (a long-term trend in the history of computing hardware in which the number of transistors that can be placed inexpensively on an integrated circuit has doubled approximately every two years), the complexity of the firmware and software engineering tasks increases. This trend has made embedded control system development vastly more expensive and time consuming.

Embedded processors used in electronic control systems are now powerful enough to run operating systems, and some of the newest processors even feature multiple “cores” just like the newest processors available in high-end desktop computers. This means that electronic control system developers must broaden their expertise even further to include new concepts, such as multi-threading, operating systems, operating system resources, device drivers, and communication protocols.

Faced with what has become a daunting task, the industry has widely adopted certain new tool chains. These include some very (often prohibitively) expensive hardware and software. The most commonly accepted design flow involves first using very academically oriented software to build a graphical flowchart of how each separate piece of the electronic control system will behave. Each of these “behavioral models” must then be simulated and tested on dedicated simulation prototyping hardware which attempts to model the real environment in which the electronic control system would operate. This prototyping hardware is very expensive and can only model real-world operation with limited accuracy. Finally, once the design has been simulated at multiple levels and is deemed acceptable, it must be “ported” to a real electronic control system—the graphical flowchart must be generated into code that will run on an embedded processor.

These industry-accepted tool chains have struggled in automating this important step of creating code from the design model. They all attempt to automatically generate code but this process is complex, time consuming and limited by the automatic code generation software. The underlying obstacle is obvious—if writing correct electronic control system code has become exceedingly difficult even for good human programmers, then writing a tool to automatically generate this code is even harder. The philosophy behind the present invention is that this task is not only difficult, but as the embedded processors grow in complexity, this approach may become entirely unfeasible.

FIG. 1 depicts traditional control system development flow. The development begins with 1, the design of the behavior model. The design is generally accomplished through a commercially available behavior modeling design software package. MathWorks, Inc., as well as other vendors, provide such software packages. The next step in the process is described with 2, 3 and 4, which are the simulation and prototyping processes. There are several vendors for prototyping hardware such as National Instruments Inc. and Dspace Inc., where a developer can download a design of a behavior model and run the control system for validation and testing. These systems are generally costly for the developer and require engineering expertise to run. Once the behavior model is determined fit for testing, 5 indicates the Code Production step where code can be automatically generated or manually written. The automatic code generation steps are not generally 100% automatic and engineering work is required to generate the code which is ready to build. Once the code is generated the development process will generally involve the steps described in 6, 7, 8 and 9. Step 6 generally involves the employment of a compiler and linker supplied by a tool vendor for the particular microprocessor used on the hardware platform. The tool chain employed in step 6 is generally costly and requires a software engineering resource. Step 7 involves the actual testing of the production level hardware control system. Step 8 describes the engineering work involved in data acquisition and behavior validation. Step 9 involves the code modification required to fulfill step 8 which in turn must be compiled, linked and downloaded as indicated in 6. This is an iterative process where the system is modified in order to tune the behavior to be coherent with the intended behavior in the original design. Several software packages are available that can be purchased to assist the developer in the porting to production level hardware platform and help to manage the various complexities involved in steps 6, 7, 8 and 9. These software packages will generally add substantial cost to the development cycle and require additional engineering resources to learn the software. In the case where the behavior model design is changed, 1, the entire sequence of 2-9 must be repeated which in turn leads to long development cycles. At a minimum, the Code Production 5 must be repeated and the iterative validation of steps 6, 7, 8 and 9 must be conducted.

### BRIEF SUMMARY OF THE INVENTION

An advantage of the present disclosure is that a system and method of dynamically modifying system behavior is provided that is cost effective and efficient. The development of the control system model directly on the production level hardware system is more efficient in both time to market and cost. The developer will save on costly prototyping hardware, costly development software tools, multiple engineering discipline requirements and longer development cycles. FIG. 2 describes the control system development flow of the present invention. The behavior model design 9 is the similar to 1 described in FIG. 1. The advantage of the present invention is that the design is down loaded directly to the production hardware platform and not to a separate prototyping hardware system as seen in FIG. 1 step 2, 3 and 4. The behavior model is prototyped directly on the production hardware platform as seen in FIG. 2 step 10. The iterative development process of 1, 10 and 11 are conducted as the developer converges on the desired behavior and development cycles are shortened due to the more direct approach of the present invention. Still another advantage of the present disclosure is that a system and method is provided where the processing control and load balancing of the electronic control system can be completely managed from the host system. A further advantage of the present system is that the building blocks of the control system are down loadable to a target system to update the system behavior without the need to recompile the existing firmware image in the target system, which leads to more efficient development cycles and faster time to market.

### BRIEF DESCRIPTION OF THE SEVERAL VIEWS OF THE DRAWINGS

FIG. 1 is a diagrammatic view of the control system development flow currently used in the industry.

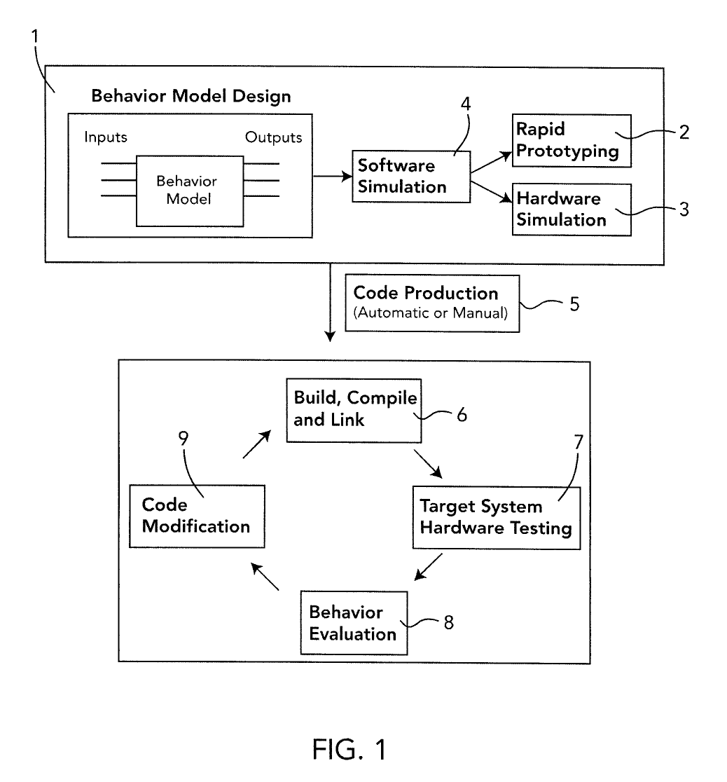

FIG. 2 is a diagrammatic view of the control system development flow offered by the present invention.

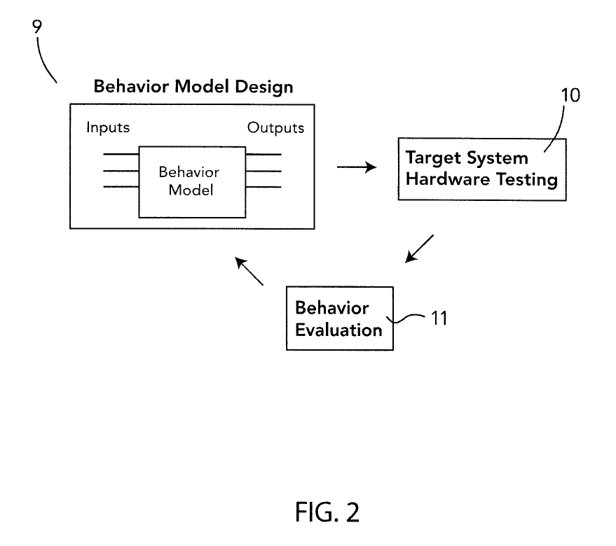

FIG. 3 is a block diagram of the host to target communication interface and the diagrammatic view of the host downloading a configuration building block to the target.

FIG. 4 is a diagrammatic view of the behavior model of the control system. This is the resulting connectivity of the system in the present invention.

FIG. 5 is a diagrammatic view of the various processing tasks in the present invention system where the task control and the configuration building block control is graphically represented.

### DETAILED DESCRIPTION OF THE INVENTION

The embodiment of the present invention concerns the dynamic building of a behavior model directly on a hardware platform. The electronic control system is referred to as the target in the present invention. The electronic control system is a hardware platform that is the target of the behavior model design. The behavior model will be dynamically constructed on the target hardware system, thereby enabling the hardware platform to read input and control output in order to generate the desired control system behavior. The host system is the development platform where a developer can connect to the target hardware platform. The host system is generally a personal computer but can be any system capable of communicating to the target using the correct communication protocol.

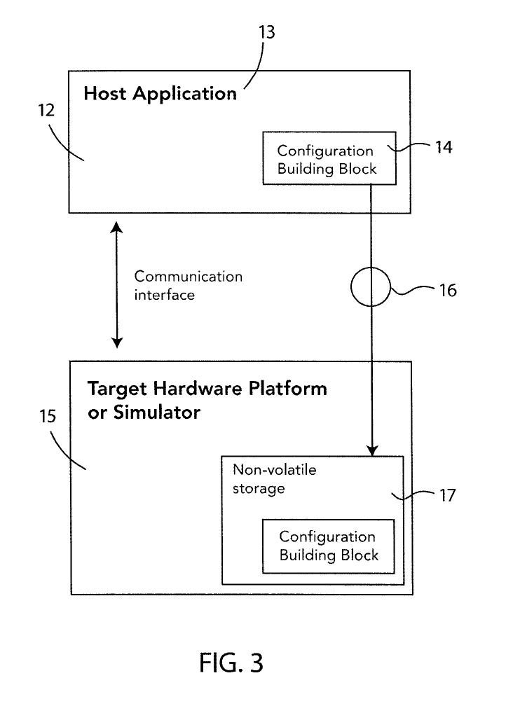

FIG. 3 describes the connection of the host system to the target system. 12 describes the host system and 13 indicates the application program that runs on the host that can communicate to the target hardware platform 15. The host application 13 will present the developer with an interface where the developer can create a configuration building block 14. A configuration building block 14 is an object that describes a part of the behavior that will be created on the target hardware system 15. The configuration building block will be part of the mathematical computation, timing control or the hardware input and output behavior of the target hardware system 15. The configuration building block 14 can be one of several different types of building blocks that can be processed on the target system. The configuration building block 14 can be a microcode block that is interpreted in a state machine on the target hardware system 15. The configuration building block 14 can be a built-in command description and data that can be interpreted on the target hardware system 15. The configuration building block 14 can be machine object code that can be executed directly on the microprocessor of the target hardware system 15. 16 indicates the process where the configuration building block 14 can be downloaded to target hardware system 15. The configuration building block 14 will be saved in the non-volatile storage 17 of the target system 15. The storing of the 14 in the non-volatile storage 17 of the target hardware system 15 will allow the retrieval of the configuration building block 14 in the event of a power cycle. The process 16 also indicates that the host application 13 allows the developer to view, modify and delete configuration building block 14 if so desired.

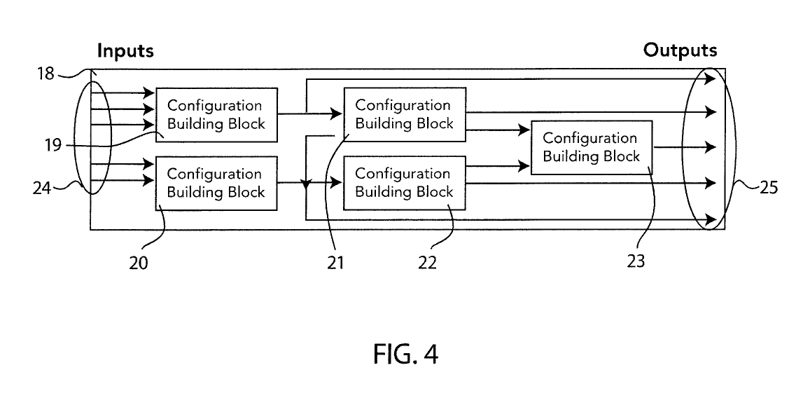

FIG. 4 describes the behavior model as a connected graph in the target hardware system. The behavior connectivity system described in FIG. 4 can contain any number of configuration building blocks and is limited by the system resources of the target hardware system. Box 18 shows an example of a system containing a behavior model that consists of five configuration building blocks 19, 20, 21, 22 and 23. Each of the configuration building blocks would be retrieved from the non-volatile storage and assembled in the RAM of the target hardware platform. The outputs 25 of the system are determined as a function of the inputs 24 and the behavior described by the contained building blocks of the system 18. Configuration building blocks can be connected together to generate the desired behavior of the target hardware system. The said host application will provide the developer with an interface whereby the developer can connect configuration building blocks in order to create the desired behavior. Each of the configuration building blocks can be chosen by the developer from a set of configuration building blocks offered by the said host application. The configuration building blocks are downloaded to the target hardware system and the configuration is connected and assembled by the target hardware system software. The designated connectivity described in FIG. 4 will be assembled by the target hardware platform software. The processing of the configuration building blocks on the target hardware system will generate the designed behavior. The behavior connectivity system described in FIG. 4 shows the connectivity whereby configuration building block 19 and 20 are inputs to block 21 and 19 is input to block 22 and blocks 21 and 22 are inputs to block 23. The outputs of the system 25 are a full set of the output of all of the included configuration building blocks 19, 20, 21, 22 and 23 of the described system 18.

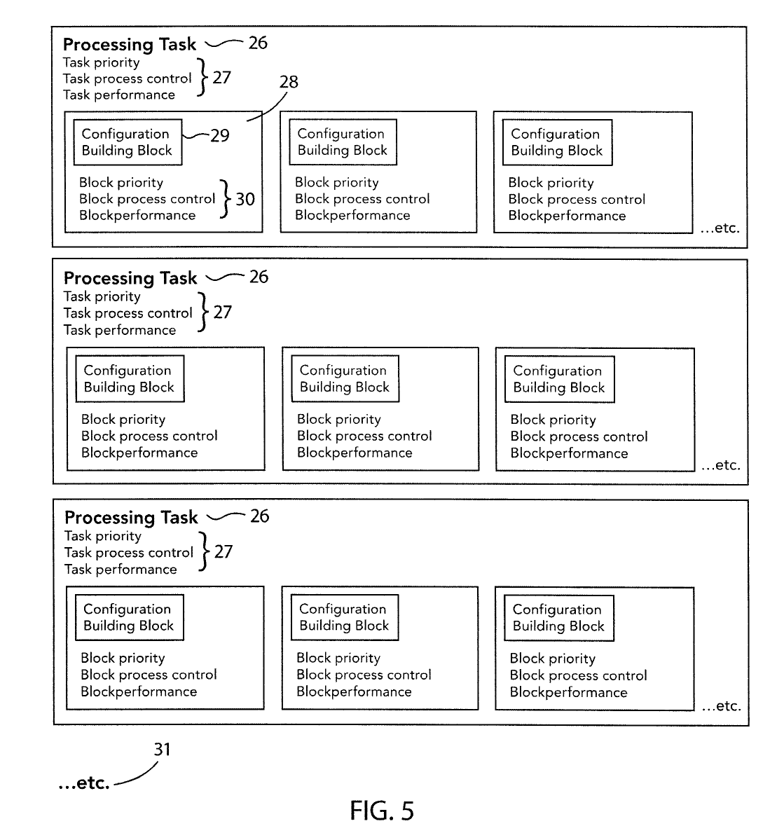

FIG. 5 describes the internal processing architecture of the present invention. The internal firmware of the said target hardware system consists of software that can process the said configuration building blocks in a precisely timed fashion in order to meet the latency and timing requirements of the designed behavior. The target hardware platform will contain software that can control the processing state of the microprocessor and manage the resources including ROM (read only memory), EEPROM (electrically erasable programmable read only memory), RAM (random access memory), hardware input and hardware output. The target hardware system will generally employ a RTOS (real time operating system) to manage the microprocessor execution and said resources. The present invention will abstract the details of the microprocessor execution and said resources and expose a flexible control interface to the developer in the said host application. The abstraction on the microprocessor execution and said resources is designed in the present invention to allow the developer complete flexibility in order to maintain microprocessor execution load balancing and the hardware timing requirements of the designed behavior model.

FIG. 5 is a block diagrammatic view of the processing architecture of present invention. The processing task 26 is the microprocessor execution control structure. The processing task 26 can also be referred to as a processing thread as these terms are synonymous. The operating system or internal software of the said target hardware platform will have the ability to allocate microprocessor execution to a processing task 26 and then switch context to a different processing task. 31 indicates that there are many processing tasks 26 in the system and that the number of processing tasks is limited only by the system resources on a particular target hardware system. In order to allow full control over the microprocessor execution, the present invention will expose the processing task control parameters 27 to the developer through the said host application. The task priority, task process control and task performance parameters are exposed to the user as configuration building blocks where the user can modify the values in order to tune the processing to generate the desired system behavior. The task priority will control the task switching arbitration of the underlying microprocessor execution management system. Task process control will adjust the task sleep time between processing the configuration building blocks within the processing task. The sleep time will tell the underlying microprocessor execution control to switch away from the current processing task 26 for the requested time. The task performance parameter will expose the microprocessor execution time to the developer so that the microprocessor execution bandwidth can be load balanced to allow the system to fulfill the computational requirements of the entire control model. The developer can monitor the task performance and adjust the task priority and task process control to adjust the system to achieve the required behavior.

Along with the ability to tune the microprocessor execution of the processing task 26, the present invention contains a configuration building block processing control 28. The configuration building block processing control allows the developer to control the processing behavior of each of the blocks independently in the system. Each of the said configuration building blocks 29 has block priority, block process control and block performance 30 which control the processing behavior of each of the blocks independently. The said host application will expose the block priority, block process control and block performance 27 to the developer and the developer can modify these parameters to tune the system to generate the desired system behavior. The block priority will control the processing order for a given configuration building block. The block process control will adjust the frequency for which a configuration control block is processed within a particular processing thread. The block process control could be exposed as an iterative count value, which controls the frequency for which a configuration building block is computed. A configuration building block with a process control value of 4 would be processed every 4th iteration of the processing task. The block process control can also schedule a block to be processed based on a scheduled system event. The block process control will have a full spectrum of flexibility whereby the developer can have full control of the processing of the configuration building block as specified from the host application. The block performance value will be the microprocessor execution time required to compute the particular configuration building block. The developer can monitor the block performance and adjust the block priority and block process control to achieve the required behavior.

The advantage of the present invention is that the management of the microprocessor execution and said resources is abstracted from the developer so that the complexity of this management can be off loaded from the developer. The developer does not need to be burdened with the complex details of task management and system resource management required in the programming of a RTOS (real time operating system). Another advantage of the present invention strategy of abstracting the management of the microprocessor execution and system resources is that the underlying RTOS (real time operating system) can be changed or ported to a completely new system and the present invention exposure to the developer would not be changed. This will allow for porting the present invention to any microprocessor or any hardware or any operating system available in the market. The development of the control system model described in this application is a novel approach and will prove to be more efficient and less costly and will gain significant traction in the industry going forward.

Many modifications and variations of the present invention are possible in light of the above teachings. Therefore, within the scope of the appended claims, the present invention may be practiced other than as specifically described.

1. A method for dynamically building a control system directly on a target hardware system, the method comprising the steps of:
providing an interface for downloading at least one configuration building block of the control system;
selectively defining a type of the at least one configuration building block using a host application on a host computer system; and
selectively defining connectivity of the at least one configuration building block using the host application on the host computer system.

2. The method of claim 1, further comprising the step of:
selectively defining a microprocessor execution control through modification of parameters for task priority, task process control (sleep control) using said host application on said host computer system.

3. The method of claim 1, further comprising the step of:
selectively defining configuration block priority ordering, and configuration building block process control using said host application on said host computer system.

4. The method of claim 1, further comprising the step of modifying or deleting at least one of a configuration building block on said target hardware system.

5. The method of claim 1, wherein said at least one configuration building block is stored in a non-volatile memory of said target system.

6. The method of claim 3, wherein said configuration building block process control specifies a processing frequency within a processing task or scheduling of the block processing based on a system event.

7. The method of claim 1, wherein said at least one configuration building block is selected from the group consisting of:
a microcode block processed by an interpreter on said target hardware system; and
machine object code executed directly on a microprocessor of said target hardware system.

8. A method for dynamically building a control system directly on a target hardware system, the method comprising the steps of:
providing an interface for downloading at least one configuration building block of the control system;
selectively defining a type of the at least one configuration building block using a host application on a host computer system;
selectively defining connectivity of the at least one configuration building block using the host application on the host computer system;
selectively defining a microprocessor execution control through modification of parameters for task priority, task process control (sleep control) using the host application on the host computer system; and
selectively defining configuration block priority ordering, and configuration building block process control using the host application on the host computer system.

9. The method of claim 8, further comprising the step of modifying or deleting at least one of a configuration building block on said target hardware system.

10. The method of claim 8, wherein said at least one configuration building block is stored in a non-volatile memory of said target system.

11. The method of claim 8, wherein said configuration building block process control specifies a processing frequency within a processing task or scheduling of the block processing based on a system event.

12. The method of claim 8, wherein said at least one configuration building block is selected from the group consisting of:
a microcode block processed by an interpreter on said target hardware system; and
machine object code executed directly on a microprocessor of said target hardware system.
